(19) United States
(12) Patent Application Publication
(10) Pub. No.: US 2026/0176512 A1
(43) Pub. Date: Jun. 25, 2026

(54) DEVICE AND METHOD FOR FREEZING PRE-MIXED TWO-COMPONENT SEALANT COMPOSITIONS

(71) Applicant: CHEMETALL GMBH, Frankfurt (DE)

(72) Inventor: Heinz BUROCK, Frankfurt (DE)

(21) Appl. No.: 19/129,357

(22) PCT Filed: Dec. 6, 2023
(86) PCT No.: PCT/EP2023/084568

§ 371 Date: May 13, 2025

(30) Foreign Application Priority Data
Dec. 7, 2022 (EP) 22211873.9

(51) Int. Cl. C09K 3/10; B65B 63/00

(52) U.S. Cl. CPC C09K 3/1012; B65B 63/00; B65B 2220/24; C09K 2200/0239; C09K 2200/0645

(57) ABSTRACT

Described herein is a method of freezing a pre-mixed processable two-component sealant, the method including the steps of providing a pre-mixed processable two-component sealant in a sealed container; subsequently cooling the pre-mixed processable two-component sealant in the container with a coolant; the coolant not being in direct contact with the sealed container containing the pre-mixed processable two-component sealant; and the cooling being performed at a cooling rate allowing the pre-mixed processable two-component sealant to be cooled to a temperature at which a reaction between ingredients of the pre-mixed processable two-component sealant is suppressed and any pre-mature curing of the sealant has not proceeded to form an unprocessable two-component sealant. Also described herein is a device for freezing a pre-mixed processable two-component sealant, the device including a base plate; and one or more cylindric tubes. The device can be used in the method of freezing a pre-mixed processable two-component sealant.

The invention relates to a method for freezing pre-mixed two-component compositions and a device for use in this method. The method and device are particularly useful to freeze two-pack sealant compositions, preferably those containing hollow spheres. Such sealants being particularly useful in sealing aircraft parts.

### BACKGROUND

In the sealants industry, it is common to employ so-called two-component compositions for sealing. As used herein, a “two-component composition” is a composition, which typically comprises one base component containing a curable resin and one further crosslinking component (also called hardener) containing a curing agent. The two components are stored separately to avoid pre-mature curing during storage, and each of both components alone does typically not qualify as a sealant. Upon mixing of both components, a curing reaction starts and the processing time begins. The processing time, wherein processing the mixture is possible, is also called “pot-life” of the compositions.

In some cases, it is not suitable or even not possible to mix the components at the location of application. In such cases, alternatively, storage-stable one-component compositions might be used, which may contain curable resins and curing agents in one and the same component. This can be accomplished by selecting curable resins and curing agents in a way that there is no significant reaction between the curable resins and curing agents during storage, but only after heating the composition to an elevated temperature. However, heating also restricts the application area to those applications, where it is possible to apply heat at the location of use and where the substrate and the to be cured composition and its ingredients are compatible with the application of heat. For example, large substrates as those in the aircraft industry are typically not be suitable for heat-curing in an oven; or sealant compositions containing air- and/or gas-filled hollow filler particles might not be suitable to be used at high temperatures, because of the expansion of the air or gas in the hollow filler particles.

Yet another type of one-component sealants are moisture-curing one-component compositions, which may cure at ambient temperature upon contact with moisture from the air.

Thus, where mixing the ingredients at the place of application or heat-curing is not possible or undesirable; or where moisture curable compositions may not provide the desired properties, it might be unavoidable to use two-component compositions such as two-component sealants for the desired purpose.

To accomplish this, a state-of-the-art approach comprises the formation of a homogeneous pre-mix of the components of the two-component system and to slow down the curing reaction of the pre-mix by freezing the pre-mix in a container immediately after formation.

Common regulations, such as from Bombardier particularly for polysulfide and polythioether sealants (BAERD Gen-015), call for freezing sealant-filled storage containers in cold baths to ensure that the temperature drop is very rapid. In all cases, direct heat dissipation through contact of the refrigerant with the outer wall of the storage container comprising the sealant is required.

However, this procedure is still adapted to sealing compounds that do not contain hollow packings. Sealant compositions containing hollow packings, such as hollow microspheres are not suitable for being frozen by the prior art freezing methods, since the hollow packings (hollow fillers) are typically damaged resulting in sealant compositions which do no longer fulfill the specifications.

Furthermore, due to the low specific weight of most sealing compounds comprising hollow fillers, they also tend to undergo strong volume changes when the temperature drops. If such sealants are filled into cartridges, which are closed on one side with a closure, such as a screw or plug-in cap, and on the other side with a movable piston, in the event of a severe temperature drop, the sealant shrinks, which means that the piston must also follow the shrinking sealant. In the case of sealants that are deep-frozen by direct contact to cold baths, however, the piston must lie very close to the cartridge wall, which means that it cannot follow the changing volume of the sealant. In this case, air enters the cartridge due to the vacuum created, or even the cold bath can be sucked in.

Moreover, modern sealing compounds often contain microspheres filled with air and/or gas, which react very sensitively to pressure or pressure changes. Excessive pressure or even a very rapid change in pressure often causes these spheres to swell or even shrink, which can lead to complete failure of this type of filler. In this case, the air and/or gas used in the microspheres is expected to escape. The air and/or gas is then released into the product surrounding them, resulting in a foamy consistency.

Furthermore, since sealants in the aviation industry are increasingly being processed using automated application methods, and in order to fully exploit the potential of such automated application processes, the sealants used must be applied without imperfections, such as those caused by the inclusion of air or gas bubbles.

Consequently, there is a need to provide a method of freezing two-component sealants which is gentler and allows to overcome the prior art problems, particularly the problems regarding the entering of air or coolant into the cartridge while freezing, thus leading to inhomogeneity due to the formation of bubbles by entrapped air or coolant. Even more particularly the problems associated with sealants containing hollow packings should be solved. The method should be gentler in that hollow packings are not damaged during the process. However, the method should be applicable to any two-component sealant, whether filled with hollow packings or not. Furthermore, a device for use in the method of the invention should be provided.

### SUMMARY

The afore-mentioned problems were solved by providing a method of freezing a pre-mixed processable two-component sealant, the method comprising the steps of
a. providing a pre-mixed processable two-component sealant (S) in a sealed container (6); and
b. cooling the pre-mixed processable two-component sealant (S) in the container (6) with a coolant
   i. the coolant not being in direct contact with the sealed container (6) containing the pre-mixed processable two-component sealant (S),
   ii. the cooling being performed at a cooling rate allowing the pre-mixed processable two-component sealant (S) to be cooled to a temperature at which a reaction between ingredients of the pre-mixed processable two-component sealant (S) is suppressed and any pre-mature curing of the sealant has not proceeded to form an unprocessable two-component sealant.

This method is also referred to hereinafter as the “method of the invention”, “method according to the invention” or “inventive method”.

The term “sealant” as used herein is equivalent to “sealing composition” and “sealant compound,” terms which are also widely used in this sector of art.

The term “freezing” in “a method of freezing” is to be understood as cooling the pre-mixed processable two-component sealant from a fluid state, semi-fluid state or paste state to a solid state.

A “two-component sealant” or “two-component sealing composition” is a composition, which typically comprises a base component containing a curable resin and a further crosslinking component (also called hardener) containing a curing agent, wherein the two components are typically stored separately to avoid pre-mature curing during storage, and where each of both components alone do typically not qualify as a sealant. Upon mixing of both components, a curing reaction starts and the processing time begins. The period wherein the sealant is processable is also called “pot-life” of the composition.

The term “pre-mixed” in view of the “two-component sealant” means that the components, which are typically stored separately have been mixed, preferably to a homogenous state.

The term “processable” with respect to the “pre-mixed two-component sealant” primarily means that the pre-mixed two-component composition has not fully cured. This does not exclude some “pre-mature curing” which already occurs during the formation of the pre-mix or while cooling down the pre-mix. Thus, the term “processable” particularly means that the sealant composition is in a state within its “pot-life” under processing conditions, i.e., the conditions under which the sealant is used as a ready-to-use sealant.

“Suppressing” a reaction between the ingredients of the pre-mixed processable two-component sealant means that the reaction is slowed down, typically to an extend that a reaction between the components of the pre-mixed processable two-component sealant is inhibited. This is typically due to the solid stated of pre-mixed two-component sealant after cooling, where the mutually reactive ingredients cannot significantly cure.

The term “coolant” denotes a solid or liquid cooling material possessing a temperature which is lower than the temperature at which the pre-mixed processable two-component sealant reaches a solid state. The term does explicitly not encompass gaseous cold media such as cold air.

A further subject matter claimed in the present invention is a device for freezing a pre-mixed processable two-component sealant, which can suitably be used in the method according to the invention. The freezing device is characterized in that the device comprises
a base plate (2),
one or more cylindric tubes (3) possessing
   a top end (3.1),
   a bottom end (3.2),
   a lateral wall having an inner wall surface (3.3i) and an outer wall surface (3.3o),
the one or more cylindric tubes (3) being perpendicularly arranged with their bottom end (3.2) on the base plate (2),
the one or more cylindric tubes (3) possessing one or more spacing elements (4) at the inner wall surface (3.3i) of the lateral wall of the cylindric tubes (3) and/or one or more spacing elements (4.5) attached to the base plate (2).

The device is also referred to hereinafter as the “device of the invention”, “device according to the invention” or “inventive device”.

### DETAILED DESCRIPTION

In the following the method and device according to the invention will be described in more detail.

### Method of Freezing a Pre-Mixed Processable Two-Component Sealant (S)

### Step a.

The method according to the invention comprises a first step a. which is providing a pre-mixed processable two-component sealant (S) in a sealed container (6).

To provide such pre-mixed processable two-component sealant (S) in a sealed container (6) a pre-mixed processable two-component sealant (S) is to be formed.

The method of the invention is not particularly limited to freezing specific two-component sealants (S), but suitable for use with any type of two-component sealants (S). Such sealants (S) preferably, but not necessarily contain fillers. The present invention is however particularly suitable and advantageous, if the sealant (S) contains one or more types of hollow fillers, such as hollow microspheres, which may be air-filled and/or gas-filled. Particularly preferred are hollow glass microspheres filled with air and/or gas.

Most preferred sealants (S) for use in the method of the invention are those used in the aviation industry, such as fuselage and fuel tank sealants. Typical sealants (S) used in the aviation industry, particularly for the afore-mentioned purposes, contain one or more polysulfide polymers and/or one or more polythioether polymers in the base component, and in the crosslinking component one or more oxidizing crosslinking agents such as manganese-(IV)-oxide or one or more crosslinking agents reacting by addition reaction such as polyisocyanate compounds or epoxy compounds; and one or more air-filled and/or gas-filled hollow fillers.

The mixing of the two components can be carried out in specially designed two-component cartridges equipped with a special mixer, i.e., the container (6) comprising the finally pre-mixed processable two-component sealant (S) itself may contain a mixing device; or the mixing can be carried out continuously or shot-by-shot in a two-component unit, which allows the then ready-mixed product to be filled into commercially available containers (6), such as cartridges, cups, or syringes. The present invention is particularly suitable, if mixing is carried out outside the to be filled and sealed container (6) and the pre-mix is, subsequently to the mixing procedure, filled into the container without delay.

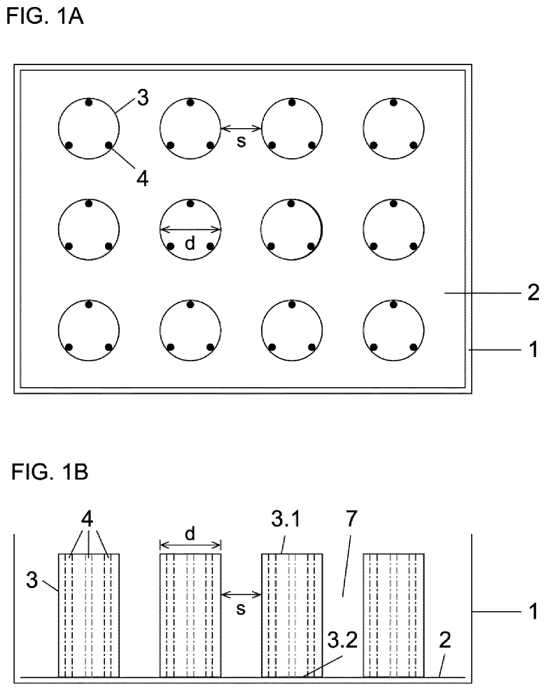

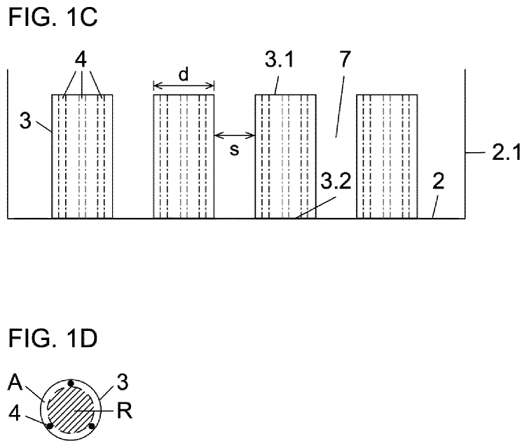

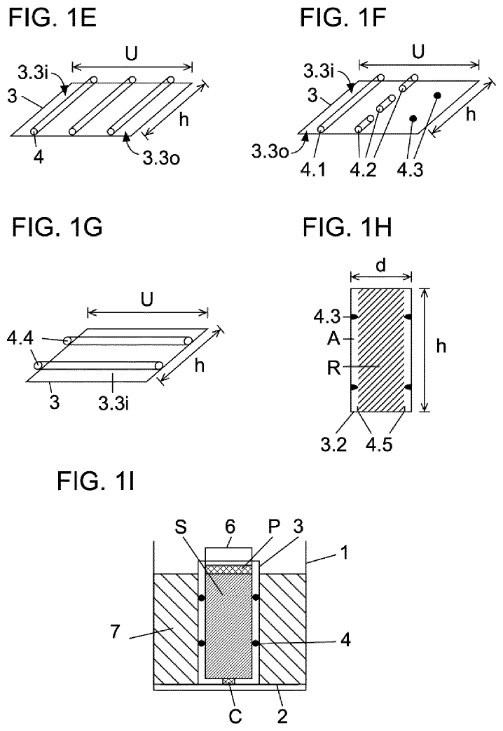

The sealed containers (6) are preferably cartridges (6), which are closed on one side with a closure (C), such as a screw or plug-in cap, while a movable piston (P) is inserted on the other side of the cartridge (6), thus sealing the cartridge from both sides. Furthermore, it is highly preferred that the piston (P) of such cartridge (6) which seals the cartridge (6) is located near the top end (3.1) of the cylindric tube (3) at a height above the filling height of the coolant in the area (7) surrounding the cylindric tubes (3) and contacting the outer wall surface (3.3o) of the cylindric tube (3), thus preventing any temperature stress at the level of the piston (P) (see FIG. 1I).

### Step b.

In step b. the pre-mixed processable two-component sealant (S) which is in the sealed container (C) is cooled with a coolant.

The purpose of this step is to cool down the pre-mixed processable two-component sealant (S) gently, but still rapidly to slow down the reaction between the ingredients of the pre-mixed sealant (S). In practice, this is accomplished when the sealant is in a frozen, solid state and the temperature reached throughout the sealed container (6) is in the range from −10° C. to −60° C. While a reaction between the ingredients cannot be completely prevented, it is suppressed to an extend that the pre-mixed two-component sealant (S) can be stored until use at the processing site under processing conditions without excessive pre-mature curing. Consequently, after bringing the frozen pre-mixed two-component sealant (S) to processing temperature again, i.e., to a temperature at which the sealant is used for its purpose, the sealant still must be processable. As already explained above “processable” means that the sealant is in a state within its typical “pot-life” under processing conditions, i.e., under ready-to-use conditions.

It must be considered that the target temperature to which the pre-mixed processable two-component sealant (S) must be cooled to freeze, depends on the sealant ingredients and their reactivity with each other.

Generally, target freezing temperatures are the equilibrium temperatures reached inside the sealed containers (6). For typical pre-mixed processable two-component sealants the target temperatures to be reached throughout the sealed container (6) are preferably in the range from −30° C. to −60° C., more preferably in the range from −35° C. to −55° C., even more preferred in the range from −40° C. to −50° C., such as from −40° C. to −45° C. However, in many cases it is sufficient to carry out the initial freezing process in a time sufficient to cool down the pre-mixed processable two-component sealants until the reaction between the components is efficiently prevented.

It has been observed that generally pre-mixed two-component sealants (S) as used in the method according to the invention follow approximately the temperature dependence of the reaction rate according to the Arrhenius equation. This means, that a reduction of the temperature by approximately 10° C. will reduce the reaction rate by approximately 50%. As an example, reducing the temperature from ambient temperature (20° C.) to 0° C. will reduce the reaction rate twice by 50%, such that the pot-life increases approximately four times. In the completely frozen state, the reaction rate between sealant components is even more reduced. Typically, it is sufficient to leave the sealed containers (6) in the freezing device for a time sufficient to reach approximately −10° C. to −15° C., afterwards the sealed container (6), preferably the cartridge (6), can be removed and stored at preferably lower temperatures. As shown in Table 1 in the experimental part of the description, such temperature may be reached starting at room temperature (20° C.) in about 10 min, with standard cartridges (6). Nevertheless, it is preferred to cool the sealed containers (6) with the freezing device optimized for standard cartridges for about 15 to 30 min, before storage or transportation.

It was an aim of the present invention to rapidly reduce the temperature and thus to slow down the reaction rate considerably to prevent excessive pre-mature curing until the frozen state is reached, while simultaneously maintaining the integrity of the sealant (S) and particularly to avoid the entry of air into the sealed containers (6) and to avoid the damage of hollow fillers, which are preferably comprised in the sealants.

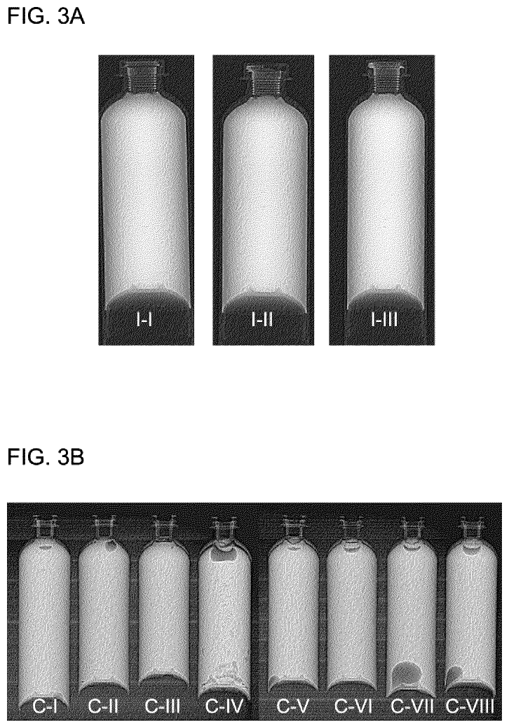

It was also observed by the present inventors, that the prior art rapid cooling methods cooling the sealed containers (6) containing the pre-mixed processable two-component sealant (S) by directly contacting the outer wall of such container with a coolant (i.e., a cooling medium), cannot accomplish this task; as, e.g., shown in FIG. 3B by X-ray pictures. Cartridges (6) containing the pre-mixed processable two-component sealant (S) show considerable amounts of entrapped air, which entered the cartridges (6) in the freezing procedure and a non-homogenous consistency of the contents of the cartridges.

To accomplish the task of fast cooling without harming the sealant and its properties was accomplished by providing the gentle freezing method according to the invention.

In the method of the invention, the sealants cool down in the sealed container at cooling rates of preferably from 1.8° C./min to 3.8° C./min, more preferably 2.0° C./min to 3.6° C./min, even more preferred 2.2° C./min to 3.5° C./min. This allows to reach the frozen state in an acceptable time range without excessive pre-mature curing of the pre-mixes sealant (S).

In accordance with the method of the invention the pre-mixed processable two-component sealant (S) in the container (6) is cooled with a coolant, however, the coolant not being in direct contact with the container (6) containing the pre-mixed processable two-component sealant (S). Thus, the coolant of the present invention indirectly cools the pre-mixed processable two-component sealant (S). This can be accomplished in that there is a coolant-free space (A) between the coolant and the container (6) containing the pre-mixed processable two-component sealant (S).

Such coolant-free space (A) between the coolant and the to be cooled sealed container containing the pre-mixed processable two-component sealant can, e.g., be realized by placing the sealed container (6) containing the pre-mixed processable two-component sealant into a cylindric tube (3) having an inner wall surface (3.3i), which has no direct contact with the outer wall of the to be cooled sealed container (6) containing the pre-mixed processable two-component sealant (S). Thus, there is a coolant-free, air-filled space (A) between the inner wall surface (3.3i) of the cylindric tube (3) and the outer wall of the to be cooled sealed container (6) containing the pre-mixed processable two-component sealant (6). The coolant is placed outside the cylindric tube (3) having direct contact with the outer wall surface (3.3o) of the cylindric tube (3), thus cooling the cylindric tube (3). In such embodiment, the cold cylindric tube (3) cools the air in the air-filled space (A) between the inner wall surface (3.3i) of the cylindric tube (3) and the outer wall surface of the sealed container containing the pre-mixed processable two-component sealant. Thus, heat transfer and cooling, respectively, take place indirectly, through the air-filled space (A). By changing the dimensions of such air-filled space (A) and the selection of a specific cooling medium with a suitable cooling temperature, it is possible to adjust the cooling rate of the sealant, thus allowing to achieve the goals of the invention for different pre-mixed two-component sealants (S) and geometries of the sealed container (6) containing the same.

A suitable coolant for the purpose of the method according to the invention is dry ice having a temperature of approximately 78.4° C. (sublimation temperature) and being the most preferred coolant; however, other coolants, particularly dry ice mixtures with one or more organic solvents, such ketones like cyclohexanone, hydrocarbons, particularly aromatic hydrocarbons like m-xylol, alcohols like ethanol or acetonitrile can also be used in the method of the present invention. The use of dry ice is particularly preferred, because storage in deep-freezers and the transport of the frozen sealant after freezing can easily be accomplished with dry ice, while the presence of additional organic solvents would require higher precautions.

Key target of the method of the invention, besides gently freezing the pre-mixed processable two-component sealant and thus avoiding the entry of air into the sealed container (6) containing the sealant (S) as well as maintaining the integrity of hollow fillers, is of course to suppress a reaction between the ingredients of the sealant and to avoid pre-mature curing of the sealant to a point at which an unprocessable, i.e., excessively crosslinked two-component sealant is obtained. After thawing the frozen sealant and bringing it to the processing temperature, a sufficient processability and pot-life is to be guaranteed. Following the above-described method of the invention and its preferred embodiments guarantees the processability of the thawed sealant, which is ready-to-use under processing conditions.

In the following a device is described and preferred embodiments thereof, each of which can suitably be employed in the method according to the invention.

### Device for Freezing a Pre-Mixed Processable Two-Component Sealant

The freezing device of the invention is characterized in that the device comprises a base plate (2); one or more cylindric tubes (3) possessing a top end (3.1), a bottom end (3.2), a lateral wall having an inner wall surface (3.3i) and an outer wall surface (3.3o); the one or more cylindric tubes (3) being perpendicularly arranged with their bottom end (3.2) on the base plate (2); and the one or more cylindric tubes (3) possessing one or more spacing elements (4) at the inner wall surface (3.3i) of the lateral wall of the cylindric tubes (3) and/or one or more spacing elements (4.5) attached to the base plate (2). The base plate (2) preferably being a perforated base plate.

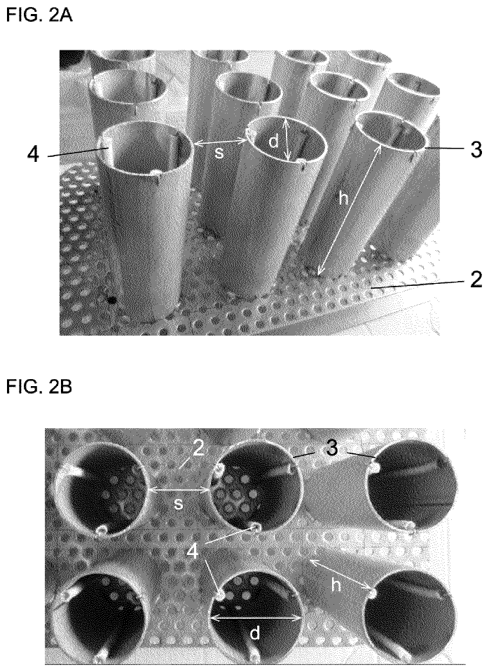

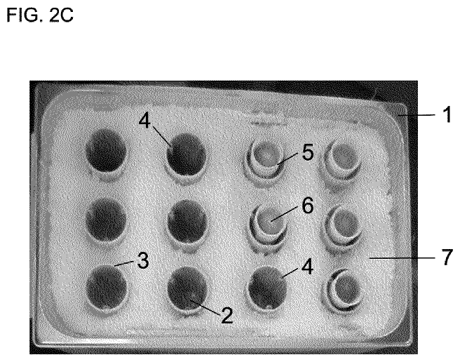

The freezing device will in the following be described in more detail by reference to FIGS. 1A to 1I and FIGS. 2A to 2C.

FIG. 1A shows a schematic top view of a freezing device of the present invention, while FIG. 1B shows a schematic side view of the freezing device of the present invention.

The freezing device as shown in FIGS. 1A and 1B, respectively, comprise a base plate (2), whereon cylindric tubes (3) having inner diameters (d) are arrange perpendicularly, i.e., in an upright position. The bottom ends (3.2) being mounted on the base plate (2) and the open top ends (3.1) being ready to receive the sealed container containing a pre-mixed processable two-component sealant. The cylindric tubes (3) being spaced from each other by a distance (s), being big enough that a coolant, such as dry ice, can easily be placed in the area (7) between and surrounding the cylindric tubes (3). The coolant will have contact with the outer wall surface (3.3o) of the lateral wall of the cylindric tubes (3). In both, FIGS. 1A and 1B, spacing elements (4) are shown to be attached to the inner wall surface (3.3i) of the lateral wall of the cylindric tubes (2). To hold the coolant in place, it is preferred to place the base plate (2), whereon the cylindric tubes (3) are attached in an open container (1), such as a tray, the side walls of the open container (1) keeping the coolant in place.

In FIG. 1C an alternative of the schematic side view of the freezing device as shown in FIG. 1B is presented. In FIG. 1C the open container (1) is not required, since the base plate (2) comprises a side wall or side walls (2.1) keeping the coolant in place.

FIG. 1D shows a schematic top view of a single cylindric tube (3). The spacing elements (4) which prevent a direct contact of the outer wall surface of the sealed container containing a pre-mixed processable two-component sealant and the inner wall surface (3.3i) of the cylindric tube define the air-filled space (A) through with heat transfer occurs. In FIG. 1D the receiving area (R) defines the area, into which the sealed container containing the pre-mixed processable two-component sealant (S) is taken.

FIG. 1E shows a perspective view of the inner wall surface (3.3.i) of cylindric tube (3) having an inner circumference (U) and a height (h). For a better presentation the cylindric tube is presented in “unfolded” form, showing the inner wall surface (3.3i) as a rectangular surface. The spacing elements (4) attached to the inner wall surface (3.3i) are exemplary also in form of tubes or strands, thus trying to minimize the contact with the outer wall surface of the sealed container (6) containing a pre-mixed processable two-component sealant (S).

However, the form and size of such spacing elements is not critical, if they are apt to serve as spacing elements (4). Thus, in FIG. 1F, a spacing element (4.1) as in FIG. 1E is shown besides a similar one in segmented form (4.2) or even in form of simple punctual elevations (4.3). FIG. 1G shows another arrangement of spacing elements (4), namely the possibility to arrange the spacing elements of FIG. 1E rotated in a 90° angle, thus forming rings (4.4) in the cylindric tube (3).

Yet another possibility of arranging spacing elements (4) is shown in FIG. 1H. Besides the possibility of punctual spacing elements (4.3), as an alternative or additional to such spacing elements present on the inner wall surface (3.3i) of the cylindric tube (3), spacing elements (4.5) can also be attached to the base plate (2) of the freezing device, thus preventing the sealed container containing a pre-mixed processable two-component sealant to contact the inner wall surface (3.3i) of the cylindric tube (3). Such spacing elements (4.5) may, e.g., extend as a circular ring from the base plate to receive the sealed container (6) containing a pre-mixed processable two-component sealant (S) in the receiving area (R) and to create a air-filled space (A).

FIG. 1I shows a schematic view of the freezing device exemplary equipped with one cylindric tube (3) attached on a base plate (2) which is placed in an open container (1), which is filled in the area (7) surrounding the cylindric tube (3) with a coolant, such as dry ice. The cylindric tube (3) being equipped with spacing elements (4) and containing a sealed container (6), here a typical cartridge (6), containing a pre-mixed processable two-component sealant (S). The part of the cartridge (6) facing the base plate (2) is sealed with a closure (C), such as a screw or plug-in cap, and the opposite part of the cartridge (6) is closed with a movable piston (P). Preferably, the filling height of the coolant in the area (7) is not higher than necessary to cool the sealed container (6) through the air-filled space (A) up to the filling height of the sealant (S) in the sealed container (6), i.e., the piston (P) is at a level above the filling height of the coolant in area (7).

FIG. 2A shows a perspective picture taken from the freezing device according to the invention as used in the examples, while FIG. 2B shows a top view of the same.

FIG. 2C shows a top view picture of an open container (1) wherein a freezing device of the invention is placed. The area (7) between the cylindric tubes (3) being filled with dry ice as a coolant. Seven of twelve cylindric tubes (3) being empty, so one can look through down to the base plate (2) which, in this embodiment is a perforated plate (2). Also shown are the spacing elements (4) in form of tubes extending along the inner wall surface (3.3i) of the lateral wall of the cylindric tube (3) from the top end (3.1) of the cylindric tube (3) to the bottom end (3.2) of the cylindric tube (3). Also shown are five cylindric tubes (3) containing a sealed container (6) containing a pre-mixed processable two-component sealant (S), wherein the wall (5) of the sealed container does not touch the inner wall surface (3.3i) of the cylindric tube (3).

It is apparent from the present invention, that the arrangement of the parts of the freezing device may depart from the specific embodiments shown in the figures above. Particularly, the shape of the spacing elements (4) is not crucial as long as they serve to create an air-filled space (A), which however should preferably guarantee a constant distance between the outer wall surface of the sealed container (6) containing a pre-mixed processable two-component sealant and the inner wall surface (3.3i) of the cylindric tube (3), to allow a uniform cooling of the pre-mixed processable two-component sealant (S). Therefore, it is also preferred that the shape of the sealed container (6) containing a pre-mixed processable two-component sealant (S) is the same as the shape of the cylindric tube (3), just smaller in diameter to fit in the receiving area (R) and to allow for the presence of the air-filled space (A).

While the size of the freezing device and the sealed containers (6) containing the pre-mixed processable two-component sealant may vary, care should be taken that the sealed containers (6) do have suitable diameters allowing to cool down the pre-mixed processable two-component sealant contained therein by heat transport through the air-filled space (A) in a time short enough to prevent pre-mature curing of the sealant resulting in the formation of an unprocessable two-component sealant.

The materials, the device is formed from, are preferably thermally stable, even at long term use. Particularly the cylindric tubes (3) should allow for an excellent heat transfer. Preferred materials for the base plate (2), the cylindric tubes (3), the open container (1) are metals or alloys, such as aluminum and stainless steel. In the present invention the sealed container (6) containing a pre-mixed processable two-component sealant is preferably a cartridge. The sealed container (6) preferably consists of a plastic material with properties that do not interfere with the freezing process, such as many soft plastic materials known to one of skill in the art, such as low-density polyethylene (LDPE).

For standard cartridges having the following dimensions, 40 to 55 mm outer diameter, and 70 to 250 mm height, and being made of LPDE, it has been found particularly suitable that the cylindric tubes (3) have an inner diameter of about 55 mm to 60 mm and the spacing elements (4) create an air-filled space (A) spacing the outer surface of the cartridge from the inner wall surface (3.3i) of the lateral wall of the cylindric tube (3) by the difference between the inner diameter of the cylindric tube (3) and the outer diameter of the cartridge (6). Thus, the air-filled gap having a width of about 5 mm to 10 mm. It is further preferred that the distance (s) between adjacent cylindric tubes is at least 30 mm, preferably at least 35 mm and most preferred in a range from 35 mm to 50 mm or 60 mm, the upper limit just being set for practical reasons to allow the use of a plurality of cylindric tubes (3) without wasting too much space on the base plate (2).

In the following the present invention is further exemplified by a working example and the results are compared with a prior art freezing method.

### EXAMPLES

### Inventive Examples I-I to I-III and Comparative Examples C-I to C-VII

Eleven standard cartridges were filled with a pre-mixed two-component, manganese-dioxide curing polysulfide polymer system with low density (Naftoseal® MC-780 Class B, commercially available from Chemetall GmbH, Frankfurt, Germany). The sealant has outstanding resistance to aviation gasoline and jet fuel, as well as resistance to the chemicals and petroleum products used in the aircraft industry and is thus suitable in sealing of aircraft parts.

The base component containing the polysulfide polymer and hollow microspheres (plastic microbubbles, “Holospheres”, 5 wt.-%) was pre-mixed with the crosslinking component (i.e., the hardener component) containing manganese oxide as an oxidizing crosslinking agent. Pre-mixing was carried out with a static/dynamic mixing device. The mixing ratio of base component to crosslinking component used in the present examples 100 parts by weight of the base component 10 parts by weight of the crosslinking component resulting in an approximate pot-life time (application time, processing time) at 23° C. being approx. 2 hours.

Immediately after pre-mixing, the cartridges were filled and sealed with a piston. Three of the thus prepared cartridges (for Inventive Examples 1-1 to I-III) where immediately placed into the freezing device shown in FIGS. 2A, 2B and 2C, the distance between the cylindric tubes being 38 mm, the inner diameter of the cylindric tubes being 56 mm and the three spacing elements being in form of hollow plastic tubes with a diameter of 6 mm extending from the top end of the cylindric tubes to the bottom end of the cylindric tubes along the inner wall surface of the lateral wall of the cylindric tube. The area between the cylindric tubes was filled with dry ice and the pistons of the cartridges were at a level slightly higher than the level of the dry ice outside of the cylindric tubes. The cartridges were left in the freezing device for 20 min until a temperature equilibrium between the sealant temperature and the temperature of the air in the air gap between the inner wall surface of the cylindric tube and the outer surface of the cartridge was reached.

A suitable minimum freezing time was determined in a separate experiment using temperature sensors in the air gap and in the center of the sealant containing cartridge. A typical temperature profile of the temperature in the center of the cartridge using the above pre-mix of Naftoseal® MC-780 Class B and dry ice as the coolant is shown in Table 1 below:

TABLE 1

| | Temperature in the center of the |
|---|---|
| Cooling time [min] | sealant containing cartridge [° C.] |
| 0 | 21 |
| 5 | 3 |
| 10 | −15 |
| 15 | −25 |
| 20 | −33 |
| 25 | −38 |
| 30 | −45 |

For the above constellation the temperature equilibrium between the air gap and the sealant temperature in the center of the cartridge is in the range from −40° C. to −45° C., which is reached after approximately 25 to 30 min.

The thus frozen pre-mixed two-component sealant containing cartridges were subjected to X-ray examination. FIG. 3A (cartridges of Inventive Examples I-I, I-II and I-III) shows that no air is entrapped in the sealant and cartridge and no foam formation occurred. To the contrary, the frozen sealant is in a perfectly homogeneous state.

After thawing the sealants in the cartridges, which were subjected to the method of the invention, the pre-mixed sealant was still fully processable at processing conditions, i.e., the sealant was in a stated within its typical pot-life.

For comparison, eight cartridges, prepared the same way as the ones prepared for the method according to the invention, were not subjected to the inventive freezing method, but to conventional freezing for 20 min in a freezing bath containing a mixture of dry ice with ethanol. In this case the cartridges had direct contact with the coolant.

The thus conventionally frozen pre-mixed two-component sealant containing cartridges were also subjected to X-ray examination. FIG. 3B (cartridges of Comparative Examples C-I to C-VIII) shows that near the closure (C) and/or near the movable piston (P) entrapments of air are observed, but in some cases also inhomogeneities throughout the sealant composition, as is particularly apparent for the cartridge of Comparative Example C-IV.

Such inhomogeneities and air entrapments are not acceptable, particularly for sealants used in the aircraft industry, e.g., for fuselage and fuel tank sealants for aircrafts.

1. A method of freezing a pre-mixed processable two-component sealant, the method comprising the steps of
a. providing a pre-mixed processable two-component sealant in a sealed container; and
b. cooling the pre-mixed processable two-component sealant in the container with a coolant,
i. the coolant not being in direct contact with the sealed container containing the pre-mixed processable two-component sealant, and
ii. the cooling being performed at a cooling rate allowing the pre-mixed processable two-component sealant to be cooled to a temperature at which a reaction between ingredients of the pre-mixed processable two-component sealant is suppressed and any pre-mature curing of the sealant has not proceeded to form an unprocessable two-component sealant.

2. The method according to claim 1, wherein the two-component sealant comprises
a base component comprising one or more polysulfide polymers and/or one or more polythioether polymers, and
a crosslinking component comprising one or more crosslinking agents selected from the group consisting of oxidizing crosslinking agents and crosslinking agents reacting by addition reaction.

3. The method according to claim 2, wherein the oxidizing crosslinking agent is manganese-oxide and the crosslinking agents reacting by addition reaction are selected from the group consisting of polyisocyanate compounds and epoxy compounds.

4. The method according to claim 2, wherein the base component comprises a polysulfide polymer and the crosslinking component comprises manganese-(IV)-oxide.

5. The method according to claim 1, wherein the sealed container is a cartridge, cup, or syringe filled with the pre-mixed processable two-component sealant.

6. The method according to claim 5, wherein the cartridge is closed on one side with a closure, such as a screw or plug-in cap, and is closed at the other side with a movable piston, thus sealing the cartridge from both sides.

7. The method according to claim 1, wherein the coolant is dry ice or a mixture of dry ice with one or more organic solvents.

8. The method according to claim 1, wherein the cooling rate in which the pre-mixed processable two-component sealant cools down in the sealed container is in the range from 1.8° C./min to 3.8° C./min.

9. The method according to claim 1, wherein the cooling is carried out until the pre-mixed processable two-component sealant is in a solid state and the temperature reached throughout the sealed container is in the range from −10° C. to −60° C.

10. The method according to claim 1, wherein the method is carried out by using the device for freezing a pre-mixed processable two-component sealant.

11. A device for freezing a pre-mixed processable two-component sealant, the device comprising
a base plate,
one or more cylindric tubes possessing
a top end,
a bottom end, and
a lateral wall having an inner wall surface and an outer wall surface, wherein the one or more cylindric tubes being perpendicularly arranged with their bottom end on the base plate, and
the one or more cylindric tubes possessing one or more spacing elements at the inner wall surface of the lateral wall of the cylindric tubes and/or one or more spacing elements attached to the base plate.

12. The device according to claim 11, wherein the device is placed in an open container, or the base plate comprises one or more side walls, the open container and the base plate comprising one or more side walls to keep the coolant in place.

13. The device according to claim 11, wherein the area surrounding the cylindric tubes is filled with the coolant up to a filling height being lower than the height of the cylindric tubes.

14. The device according to claim 11, wherein the base plate is a perforated base plate.

15. The device according to claim 11, wherein the device is for cooling sealant cartridges, the sealant cartridges having an outer diameter in the range from 45 to 55 mm and a height in the range from 70 to 250 mm, the cylindric tubes having an inner diameter in the range of 55 mm to 60 mm, the spacing elements creating an air-filled space having a width in the range of 5 mm to 10 mm, and the distance between adjacent cylindric tubes being at least 30 mm.
